(19) United States
(12) Patent Application Publication
(10) Pub. No.: US 2005/0002337 A1
(43) Pub. Date: Jan. 6, 2005

(54) Reducing effects caused by transmission channel errors during a streaming session

(75) Inventors: Ye-Kui Wang, Tampere (FI); Emre Baris Aksu, Tampere (FI)

Correspondence Address: WARE FRESSOLA VAN DER SLUYS &;ADOLPHSON, LLP, BRADFORD GREEN BUILDING 5, 755 MAIN STREET, P O BOX 224, MONROE, CT, 06468, US

(73) Assignee: Nokia Corporation

(21) Appl. No.: 10/612,401

(22) Filed: Jul. 1, 2003

(51) Int. Cl. H04J 3/14

(52) U.S. Cl. 370/235; 370/528

(57) ABSTRACT

The invention relates to a method for streaming media from a streaming server (111) to a streaming client (101) via a transmission channel (121), wherein the method comprises reducing effects caused by transmission channel error variation by applying error resilience adaptation to the streaming media. The error resilience adaptation may comprise improving or reducing error resilience properties of a streaming content during an ongoing streaming session, through, e.g, the use of a set of pre-defined error resilience levels.

### FIELD OF THE INVENTION

The invention relates to streaming media from a streaming server to a streaming client via a transmission channel.

### BACKGROUND OF THE INVENTION

Multimedia streaming is a session based, uni-directional service that may include one or more media components, such as text, speech, audio, video, graphics, which are streamed or otherwise transported in near-real-time from a dedicated streaming server (hereinafter referred to as the server) to a streaming client device (hereinafter referred to as the client) via a transmission channel which may be implemented by a wired and/or a wireless network. Typically, a number of clients can access the server over the network. The server is able to respond to requests presented by the clients.

One task for the server is to transmit a desired media stream to the client. Typically, the storage space required for ‘raw’ media content (or data) at the server is huge. In order to facilitate an attractive multimedia streaming service over generally available transmission channels such as low bit rate modem or wireless connections, the media contents are compressed before being sent (or streamed) to the client. Upon receiving the media, the client decompresses and plays the media with a small delay or no delay at all. This means that the media needs not to be downloaded as a whole before starting to play. Thus, the client does not need to store the entire media content. The media content to be transmitted may be pre-recorded, or alterenatively, media can be transmitted during a media event occurrence (such as a concert) to one or more clients as a live transmission (or live broadcast). Some examples of streaming services are as follows:
Audio streaming (e.g. providing the client with streamed audio playback)
Streaming with an audio and a video component (news reviews, music videos, movie trailers, etc.)
Audio streaming with simultaneous visual presentation comprising still images, text and/or graphical animations and/or video clips presented in a pre-defined order.

As technology in the field is developing fast, networks are becoming more effective. However, at the same time, traffic conditions in the networks are becoming more variable. The throughput bit rate may vary substantially in the course of time even during the one and same streaming session. In order to use network resources in the most appropriate way and in order to improve the Quality of Service (QoS) and user experience, a concept called (bit) rate adaptation has been introduced. This means that, e.g. if during a multimedia streaming session networks conditions change so that an available bandwidth (i.e. throughput bit rate) changes due to some reason, such as congestion, the transmission bit rate of the server can be adapted to meet the new network conditions. In practice, this may mean that the server switches to transmitting a stream having a bit rate lower (or higher) than the bit rate of the stream previously transmitted. Changing the bit rate of the media streams in this way can prevent client buffer overflow or underflow, hence experienced quality is improved. A general reference, as to the bit rate adaptation, is made to the document Tdoc S4 (03)0024, “End-to-end bit rate adaptation for PSS”, 3GPP TSG-SA WG4 Meeting #25, 20-24 Jan. 2003, San Francisco, Calif., USA (originated from Ericsson).

Although it is generally accepted that bit rate adaptation suites quite well for adapting streaming media in situations in which an available network bandwidth changes, it is not considered an ideal method for systems which undergo transmission errors or for systems in which transmission error situation on a transmission channel changes during a streaming session.

As far as transmission errors (or errors during transmission) are concerned the following error categories are generally recognized: bit errors and packet errors. Bit errors are typically caused by imperfections of physical channels, such as radio interference. Packet errors, on the other hand, are typically caused by limitations of various elements in packet-switched networks. For example, a packet router may become congested, i.e. it may receive too many packets and cannot output them, i.e. forward them to the next network element at the same rate. In such a situation, its buffer(s) overflow(s), and one or more packets get lost as a result. That kind of situation is possible, for example, with the current Internet and wireless networks, where the network buffers have a finite size.

In the following, a reference is made to document Yao Wang et al, “Error Resilient Video Coding Techniques”, IEEE Signal Processing Magazine, vol. 17, no. 4, pp. 61-82, July 2000. According to that document, in the situation just described, error-free delivery of data packets can only be achieved by allowing retransmission of lost (or damaged) packets, through mechanisms such as automatic repeat request (ARQ). Such retransmission, however, may incur delays that are unacceptable for certain real-time applications. Broadcast applications prevent the use of retransmission algorithms completely due to network flooding considerations. According to Wang et al, it is therefore important to devise media encoding/decoding schemes that can make the compressed bit stream resilient to transmission errors.

Wang et al further state that error control is especially important to compressed video streams, because the use of typical coding methods, such as predictive coding and variable-length coding (VLC), makes the transmitted stream very sensitive to transmission errors. A single erroneously recovered sample at the receiver side may lead to errors in the subsequent samples in the received picture (or frame) and/or following pictures (or frames). Likewise, a single bit error can cause the decoder to lose synchronization, so that even successive correctly received bits become useless. Many error resilient coding techniques (error resilient techniques) have been developed to provide error resilience for the compressed video and audio bit streams.

As Wang et al explain concerning a video stream, one possibility to make the compressed bit stream resilient to transmission errors is to add (or leave) redundancy into the stream, so that it is possible to detect and correct errors. The server typically has (en)coders to perform source coding and channel coding. Redundancy can be added in either the source or channel coder. Wang et al further state that even when a sample or a block of samples are missing due to transmission errors, the decoder at the client can try to estimate said sample or block of samples based on surrounding samples, by making use of inherent correlation among spatially and temporally adjacent samples. Such techniques are known as error concealment techniques. These techniques are possible if coders do not completely eliminate the redundancy in a signal in the encoding process. To limit the effect of error propagation, an encoder can periodically restart the prediction process. A consequence of this intentional deficiency of the encoder is that a transmission error may affect only a portion of a frame, which can then be estimated by interpolation.

Wang et al, as described in the foregoing, concern error resilience techniques for video streaming. For error resilience techniques for audio streams a general reference is made to document Colin Perkins et al, “A Survey of Packet Loss Recovery Techniques for Streaming Audio”, IEEE Trans. Network, vol. 12, pp. 505-515, 1998.

It is to be noted, however, that the mere fact that error resilience techniques exist does not alone bring a solution to e.g. that situation in which error characteristics on a transmission channel change during a streaming session.

### SUMMARY OF THE INVENTION

It is an object of the present invention to cope with transmission error variation during a streaming transmission.

According to a first aspect of the invention, there is provided a method for streaming media from a streaming server to a streaming client via a transmission channel, wherein the method comprises:
reducing effects caused by transmission channel error variation by applying error resilience adaptation to the streaming media.

The term media is considered to mean either video or audio or another media, such as still image, graphics, text, speech or any combination thereof, i.e. multimedia.

In an embodiment of the invention, error resilience adaptation is performed so that error resilience properties of a streaming content (to be sent to the client) are improved or reduced with the aid of pre-defined error resilience levels. In an embodiment, an error resilience level (or value) is defined for a media content or stream in accordance with the targeted highest (or maximum) data loss rate the media content or stream in question can tolerate. A set of pre-generated streams having different levels of error resiliency and having been produced by different error resilience techniques (a reference is made to the document Wang et al already introduced in the section “BACKGROUND OF THE INVENTION”) may be made available to the streaming server. Error resilience adaptation may be performed by swithing, at a suitable swithing point, a transmitted stream to a stream having a different error resilience level. Thereby, it is possible to react to changing network conditions. If the transmission error situation on the transmission channel becomes worse, the error resilience level of the transmitted streaming media may be increased. On the other hand, if the transmission error situation on the transmission channel becomes better, the error resilience level may be decreased. In this way, the user experience should relatively be increased.

An embodiment of the present invention makes use of transcoding in error resilience adaptation. When transcoding is used there is no need to have a multiplicity of pre-generated streams, but a media content may be (trans)coded by a suitable method at the time (or close to the time) of actual streaming transmission.

According to a second aspect of the invention, there is provided a client device comprising:
receiving means for receiving streaming media sent from a streaming server to the client device via a transmission channel;
detection means for detecting transmission channel errors; and
sending means for sending an error resilience adaptation request to the streaming server.

The client device may be a mobile station of a cellular network or a fixed terminal.

According to a third aspect of the invention, there is provided a streaming server comprising:
sending means for sending streaming media to a streaming client via a transmission channel; and
adaptation means for reducing effects caused by transmission channel error variation by applying error resilience adaptation to the streaming media.

According to a fourth aspect of the invention, there is provided a system comprising a streaming server, a transmission channel and a streaming client, wherein the system comprises:
transmission means for transmitting streaming media from the streaming server to the streaming client via the transmission channel; and
adaptation means for reducing effects caused by transmission channel error variation by applying error resilience adaptation to the streaming media.

According to a fifth aspect of the invention, there is provided a computer program product executable in a client device, the computer program product comprising:
program code for controlling reception of streaming media sent from a streaming server to the client device via a transmission channel;
program code for detecting transmission channel errors; and
program code for controlling sending of an error resilience adaptation request to the streaming server.

According to a sixth aspect of the invention, there is provided a computer program product executable in a streaming server, the computer program product comprising:
program code for controlling sending of streaming media to a streaming client via a transmission channel; and
program code for controlling error resilience adaptation applied to the streaming media.

Dependent claims contain preferable embodiments of the invention. The subject matter contained in dependent claims relating to a particular aspect of the invention is also applicable to other aspects of the invention.

### BRIEF DESCRIPTION OF THE DRAWINGS

Embodiments of the invention will now be described by way of example with reference to the accompanying drawings in which:

FIG. 1 shows a communications system for a streaming service;

FIG. 2 shows a media information box according to an embodiment of the invention;

FIG. 3 shows a system for streaming media according to an embodiment of the invention;

FIG. 4 illustrates a streaming server according to an embodiment of the invention;

FIG. 5 shows another illustration of the streaming server of FIG. 4;

FIG. 6 illustrates a streaming client device according to an embodiment of the invention; and

FIG. 7 shows another illustration of the streaming client device of FIG. 6.

### DETAILED DESCRIPTION

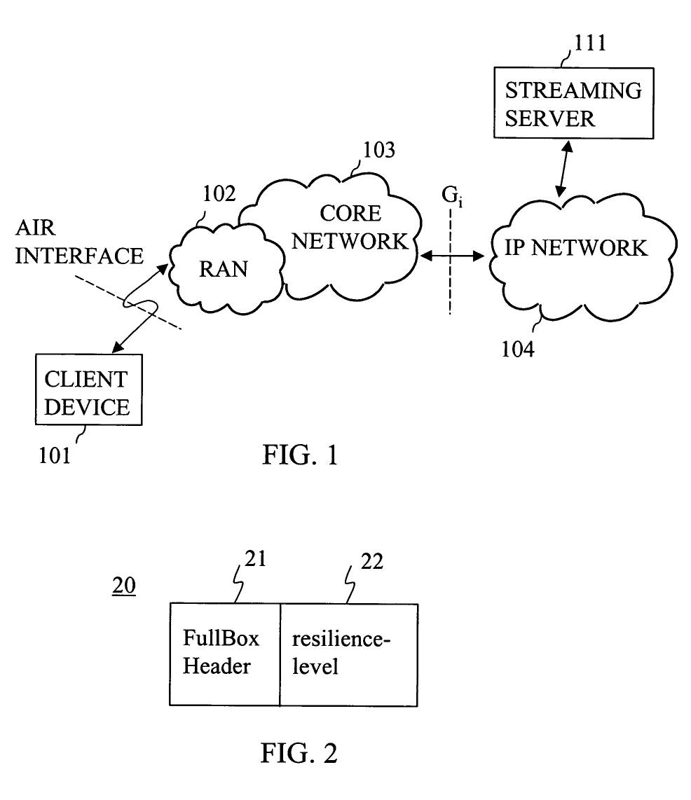

FIG. 1 shows a communications system according to an embodiment of the invention. The system comprises a streaming server 111 which is coupled to an IP-network (Internet Protocol) 104. The IP-network 104 may be, for example, the Internet or a service provider operator's intranet (an intranet network belonging to the operator's domain). The IP-network 104 is coupled to a core network 103 of a mobile communications network. The coupling may be performed via a Gᵢ interface. The mobile communications network may be, for example, a ‘2.5^{th} generation’ GPRS or EGPRS network, or a 3^{rd} or further generation cellular mobile communications network. The mobile communications network also comprises a radio access network (RAN) 102 coupled to the core network 103. The radio access network 102 provides mobile client devices 101 with access to the mobile communications network over an air-interface. The mentioned access may be provided e.g. by circuit switched means (e.g. circuit switched data call) or packet switched means (e.g. GPRS (General Packet Radio Service)). Accordingly, these techniques may be used to carry media stream packets over the air-interface portion.

It should be noted that the presence of an air interface is not necessary. The network(s) which provide(s) a transmission channel (or path) between the streaming server 111 and the streaming client 101 may consist of a fixed network or networks, such as a fixed IP-network or -networks. However, transmission errors and error variation in an environment involving a mobile network are generally considered bigger a problem than in a fixed “non-mobile” network environment.

A typical streaming process may comprise the following basic steps:
The streaming media content is created and stored in the streaming server 111. The content can be stored in a standard file format such as a file format based on ISO (International Organization for Standardization) base media file format (ISO/IEC 14496-12|15444-12 (International Electrotechnical Commission)), MP4 file format (ISO/IEC 14496-14), AVC (Advanced Video Codec) file format (ISO/IEC 14496-15), or in a 3GPP file format (3GPP TS 26.244 (3^{rd} Generation Partnership Project)).
The streaming session or presentation description is made available to the client 101. This can be done, for example, through an RTSP URL (Real Time Streaming Protocol, IETF RFC 2326, Uniform Resource Locator) or an SDP file (Session Description Protocol, IETF RFC 2327).
The client 101 requests (with the aid of an RTSP DESCRIBE method) a session description from the server 111. Capability exchange may be carried out for the server 111 to know the capabilities of the client device 101 and/or the preferences of the user. In capability exchange of the 3GPP packet-switched streaming service (3GPP TS 26.234), W3C (World Wide Web Consortium) Resource Description Framework (RDF) Schema Specification, W3C CC/PP structure and vocabularies and WAP UAProf Specification may be used.
The server 111 responds to the client 101 with the session description file (SDP).
The client 101 sends an RTSP SETUP message to the server 111 to setup a streaming media component of a streaming session. There is a separate RTSP SETUP request per media component (e.g. one for audio and one for the video media component of the session). The server 111 responds to the SETUP message.
The client 101 sends an RTSP PLAY message in order to start media data delivery (i.e. streaming of the media). The server 111 starts to deliver the requested media to the client 101.
During playback, the client 101 may decide to pause the playback and send an RTSP PAUSE request to the server 111. The server 111 stops the media data delivery to the client 101. The client 101 can resume playback using the RTSP PLAY method.
The server 111 ends the session if the playback is finished or if the client 101 issues an RTSP TEARDOWN request.

Transport of session control data may be implemented e.g. by using RTSP on top of TCP/IP (Transport Control Protocol), RTSP on top of UDP/IP (User Datagram Protocol), or HTTP (HyperText Transfer Protocol, IETF RFC 2616) on top of TCP/IP. Transport of actual media data (or content) may be implemented e.g. by using RTP (Real-time Transport Protocol, IETF RFC 1889 and 1890) on top of UDP/IP or interleaved inside RTSP messages (i.e. RTP/TCP/IP).

According to an embodiment of the invention, error resilience adaptation is supported in media (or multimedia) streaming. For that purpose a set of error resilience levels is defined. Once both the server 111 and the client 101 know their meaning, these levels can be used to control streaming media transmissions.

In this embodiment, levels of error resilience are defined according to targeted highest data loss rate. Eight error resilience levels are defined as follows:

| Error resilience level | Targeted highest data loss rate |
|---|---|
| 0 | 0% (error-free) |
| 1 | 1% |
| 2 | 2% |
| 3 | 4% |
| 4 | 8% |
| 5 | 16% |
| 6 | 32% or higher |
| 7 | unspecified. |

For example, the error resilience level 3 indicates that a media stream having that error resilience level can tolerate the highest (or maximum) data loss rate of 4% in the transmission channel without significant distortion in the received media (e.g. picture) quality. Whilst a media stream having the error resilient level 0 indicates the usage of the highest compression ratio under the coding algorithm.

According to an embodiment, a set of pre-recorded media streams is available to the server 111. Each of the streams is intentionally encoded with a different amount of error resilience, for example, by adding redundancy as described in the foregoing. A first stream may, for example, have the error resilience level 0, a second stream the error resilience level 2, a third stream the error resilience level 4 and a fourth stream the error resilience level 5. During an established streaming session the server 111 may adapt (or adjust) its transmission so that it aims to transmit the bit stream best suited for the prevailing error conditions of the transmission channel. If the initial transmitted stream is the second stream (having error resilience level 2) and the error conditions, for example, change to the worse, the server 111 can switch to transmitting another stream having a larger error resilience level. The switch is done at a suitable switching point. In this embodiment, the server 111 can, for example, switch to transmit the third stream (having error resilience level 4). The user will probably experience a small degradation in the media quality, since a stream having a higher error resilience level has a little bit worse quality than the stream having a lower error resilience level. However, a small degradation in the media quality is much better for the user experience than if the server had continued to transmit the originally transmitted stream. In that case, the quality of the media could have been, in a worst scenario, totally destroyed due to the increased data loss (or packet loss) rate.

In the preceding exemplary embodiment, eight levels of error resilience were defined. It should be noted, though, that the number of resilience levels depends on the implementation, therefore more or less than eight levels may be defined.

Media contents are typically stored at the server 111 in a specific standard file format. According to an embodiment of the invention, the error resilience values (or levels) of the available streams are stored in the file format. In this way, the server 111 will know the error resilience value of each stream and may perform error resilience adaptation by choosing a proper stream according to the prevailing network error conditions and the error resilience levels of available media contents.

As to the file formats, the ISO base media file format is currently applied for MPEG-4 Audio, Visual and AVC, and Motion JPEG2000 formats. To support resilience adaptation based on multiple encoding of the same media sequence with different levels of error resilience, the ISO base media file format may be modified to include an attribute indicating an error resilience level for the media content. Alternatively, if MP4 format or AVC format is used, these can be modify to support the same. For other media types, such as H.263 video, AMR speech (Adaptive Multi-Rate) or MPEG-4 AAC Audio, proper modifications can be done in other file formats, for example, in the 3GPP file format.

The following exemplary embodiment illustrates the modification of the ISO base media file format. It should be noted that other ways of modification are possible.

In this embodiment, a new box called Media Resilience Information Box is proposed to convey the resilience level of the specific media content (or representation). The definition of the box may be as follows:

| | |
|---|---|
| Box Type: | ‘rinf’ |
| Container: | Media Information Box (‘minf’) |
| Mandatory: | No |
| Quantity: | Zero or one |

The syntax may be:

| | |
|---|---|
| aligned(8) | class MediaResilienceInformationBox |
| | extends FullBox(‘rinf’, version = 0, flags) { |
| | template unsigned int(8) resiliencelevel = 7; |
| } | |

The semantics of the exemplary box is as follows. “Version” is an integer that specifies the version of the box. “Flags” is a 24-bit integer with flags (currently all zero). “Resiliencelevel” specifies the error resilience level of the media content (or media representation). In an embodiment which uses the definition of eight error resilience levels, the value of “resiliencelevel” is in the range from 0 to 7, inclusive, as defined in the foregoing definition of error resilience levels. If the box is not available, the default error resilience level of the media content is 7, which means an unspecified level of error resilience.

A reference is made to FIG. 2 which illustrates the Media Resilience Information Box 20 having a header 21 and the syntax element 22 (“resiliencelevel”) which is of 8 bits.

As to the modification of other possible file formats, e.g. the 3GPP file format, there is the possibility to base these file formats on the ISO base media file format as modified in the preceding. It should also be noted that other ways are possible.

According to an embodiment of the invention, information about error resilience levels is signaled between the server 111 and the client 101. In this embodiment, the server 111 may, during streaming session setup, let the client 101 know which resilience alternatives are available. After the session setup, i.e. during an established session, the client 101 may request a desired error resilience level from the server 111.

The following is an exemplary embodiment showing signaling of error resilience information between the server 111 and the client 101. In this embodiment, SDP represents a network protocol used for session setup. It should be noted that, alternatively, another protocol may be used. In this embodiment, a new attribute-line (a-line) is proposed to convey the error resilience information in the SDP session description during session setup phase. The SDP session description is sent from the server 111 to the client 101. The format of the attribute-line may be as follows:
a=resilience:l₁,l₂, . . . ,lₙ
wherein l₁ indicates the default error resilience level (e.g. level 1) and l₂, . . . , lₙ indicate other alternatives (e.g. levels 2, 3, 4 and 6) which the server 111 supports.

The embodiment just described suggests to enable the exchange of server capabilities. This is in contrast to the current specification of capability exchange in the 3GPP packet-switched streaming service (3GPP TS 26.234) which supports only exchange of client device capabilities and/or user preferences. However, exchanging server capabilities is considered advantageous, for example, for that reason that if the client 101 knows that the server 111 does not support resilience adaptation it can then avoid sending to the server 111 useless error resilience adaptation requests.

The following is another exemplary embodiment showing signaling of error resilience information between the server 111 and the client 101. This embodiment concerns streaming session control during an established streaming session. In this embodiment, RTSP represents a network protocol used for streaming session control. It should be noted that, alternatively, another protocol may be used.

A new RTSP header called “Resilience” is defined and proposed. The format of the header may be as follows:
Resilience=“Resilience” “:” 1*DIGIT,+,−

The client 111 can use the header, during an ongoing streaming session, to request a desired level of error resilience from the server 101, for example, with the aid of an RTSP OPTIONS, PAUSE, SET_PARAMETER or PLAY request, while the server 111 can use it to inform the client 101 of the error resilience level of the media being transmitted, for example in responses which it sends in response to the just mentioned RTSP requests. Alternatively or in addition, the client 101 can just simply use the header to request the server to increase or decrease the error resilience level, for example, with the aid of the RTSP OPTIONS, PAUSE, SET_PARAMETER or PLAY request.

For example the header with value 0, such as:
Resilience: 0
would indicate a request for transmission for error-free conditions, whereas the header with the “+” sign, such as:
Resilience: +
would indicate a request to start transmitting a stream having a higher error resilience level.

The client 101 may also query from the server 111 the current resilience level being used with an RTSP GET_PARAMETER request, e.g. to check the latest resilience level after a series of resilience level increment or decrement messages.

Actions relating to streaming initialization have already been described in the preceding description in connection with the embodiment showing the basic steps of the streaming process. In the following embodiment, the streaming session initialization will be more closely described in the view of error resilience adaptation.

Basically, it is assumed that the server 111 has alternatives of different error resilience levels available. In this case, the client 101 understanding the alternatives can select an alternative to start with. The alternatives can be made available, for example, using the proposed SDP attribute. An initial selection can be done using, for example, the proposed RTSP header. The basic initialization steps are as follows:
The client 101 requests (with the aid of the RTSP DESCRIBE method) or retrieves (with the aid of the HTTP method) a session description from the server 111. Capability exchange may be carried out to exchange the client device's capabilities and/or the user preferences and the server capabilities. Through capability exchange, the client 101 may get to know that the server 111 supports error resilience adaptation.
The server 111 responds with or delivers the session description, SDP, containing the available error resilience levels by employing the proposed SDP attribute.
The client 101 selects the most suitable error resilience level from the given alternatives.
The media streams are set up with the aid of the RTSP SETUP method. The selected alternative is signaled to the server 111 by using the proposed RTSP header.
Network resources are requested. If resources are reserved, a possible guaranteed (maximum) transmission error rate should correspond to the selected error resilience level alternative.
The client 101 starts the media delivery with the RTSP PLAY request. At the time of sending the PLAY request the client 101 may select to start playback using another error resilience level than the one selected with the SETUP message. If, for example, the appropriate transmission error rate could not be guaranteed, a new alternative error resilience level can be requested at this stage employing the proposed RTSP header.

The following exemplary embodiments show error resilience adaptation action during an already established streaming session. In other words, there is a streaming session established, but during the session network conditions change, thereby causing either an increase or degrease in the transmission error rate (or data loss rate).

The first of these exemplary embodiments is an example of server-based adaptation. In this scenario only the server 111 decides whether and when error resilience adaptation is done. The decision is based on information which it receives in RTCP (RTP Control Protocol) receiver reports sent by the client 101. RTCP is an integral part of RTP and it is used to produce feedback and statistic information relating to streaming transmissions. Among other things, RTCP reports indicate important information on errors and packet losses on the transmission channel to support adaptation decisions. A typical course of action according to the present embodiment is as follows:
The transmission error rate is increased due to network variations.
The client 101 sends periodic RTCP receiver reports to the server 111. If a report shows a significant change in network conditions (e.g. indications of high rates of fragments lost information), the server 111 draws the conclusion that adapting to another resilience level is necessary. However, it should be noted that the increase of the error rate might not be clearly enough visible in the statistics coming in a report right after the error rate has changed. Therefore, more than one report after the change might need to be received by the server 111 before drawing the conclusion that there is need for adaptation.
The server 111 makes the decision to change to a higher error resilience level alternative. The new error resilience level is sent out. The new error resilience level may be informed to the client 111 by using the proposed RTSP header. The error resilience adaptation may be, for example, based on multiple encodings or transcoding. If it is based on multiple encodings this means that the server switches from sending a first pre-generated (or pre-encoded) stream to sending a second pre-generated stream meeting the new error resilience level). If it is based on transcoding, this means that the media content simply is transcoded before it is transmitted (so there is typically only one encoded stream stored on the server side).
The media quality at the client is relatively improved because of improved error resilience.

The second exemplary embodiment presents a scenario in which the client 101 and the server 111 co-operatively decide whether and when error resilience adaptation is needed. A typical course of action according to this embodiment is as follows:
The transmission error rate is increased due to network variations.
The client 101 detects, based on its own measurements (the same measurements that are used to generate the RTCP reports), that transmission error rate is increased.
The client 101 sends to the server 111 a request to adapt to a higher resilience level media stream alternative, using the proposed RTSP header.
The server 111 acknowledges and starts sending a stream with the requested higher error resilience level. Also here, the error resilience adaptation may be, for example, based on multiple encodings or transcoding.
The client 101 starts to receive the new stream.
The server 111 may verify that the decision was correct by looking at the following RTCP reports.

Depending on the implementation, it may be arranged that the server 111 has the ultimate power to either accept or reject the client's request. In such a situation, if the server does not find error resilience adaptation appropriate, it may reject the error resilience adaptation request presented by the client.

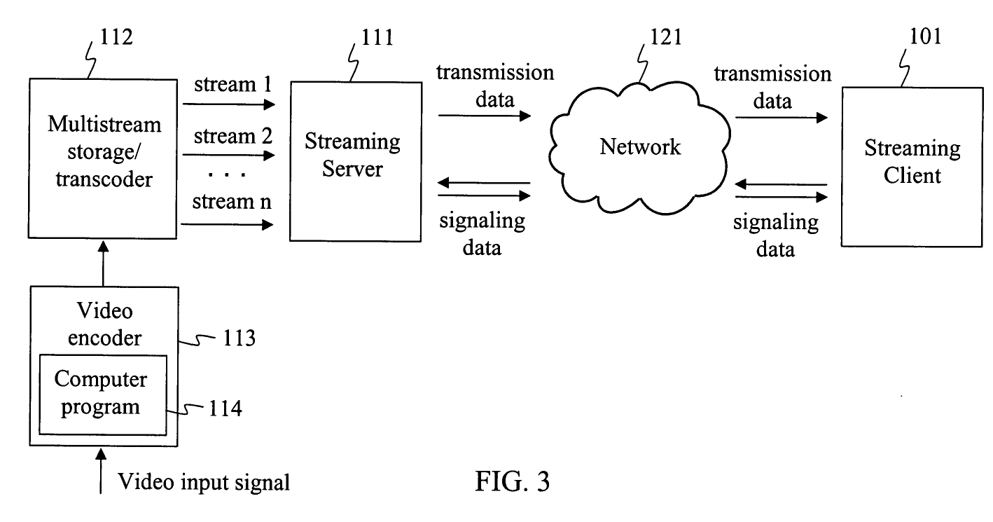

FIG. 3 shows a system for streaming media according to an embodiment of the invention. The system comprises the server 111 and the client 101. The server 111 sends streaming media (transmission data) to the client 101 via a transmission channel (or path) provided by the network 121. The network 121 may be a single network or a combination of different networks as illustrated in FIG. 1. The client 101 sends signaling data to the server 111 via a signaling channel (or route) provided by the network 121. This signaling data may comprise, among other things, a request for adapting error resilience levels, as described in the foregoing. The server 111 also sends signaling data to the client 101 via a signaling channel provided by the network 121. This signaling data may comprise, among other things, information on the error resilience level(s) of the media stream(s) being transmitted, as described in the foregoing.

The system comprises a media encoder 113 (here: video encoder) which encodes the received media signal (here: video signal). The encoding is controlled by a computer program 114. The output of the media encoder is a compressed bit-stream which is then conveyed to a unit 112 which stores the stream. The unit 112 may be implemented as a part of the streaming server 111. As described in the foregoing, a set of streams (streams 1 to n) having different levels of error resiliency can be generated in advance (the multiple encoding method). The streaming server 111 then selects the one to be transmitted. The set of streams may be generated by running the media encoder 113 multiple times and by storing the outputted multiple streams in the unit 112. Alternatively, if transcoding is used, the transcoding is performed by the unit 112 comprising a transcoder.

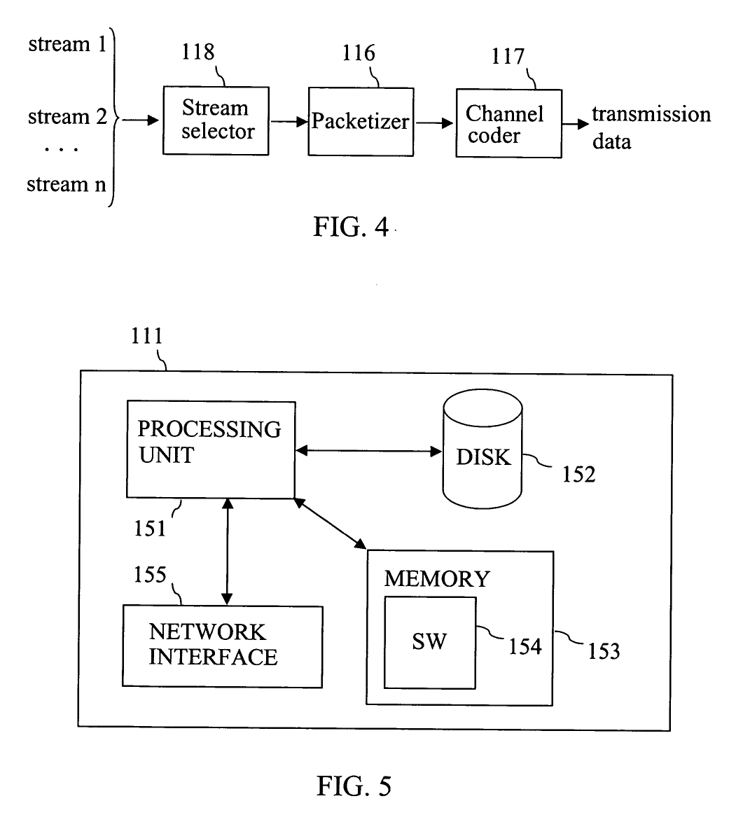

FIG. 4 illustrates a streaming server 111 according to an embodiment of the invention. The server 111 comprises a stream selector block 118, a packetizer block 116 and a channel encoder block 117. The stream selector 118 selects a stream amongst the available streams according to conditions relating to error resilience levels. The packetizer 116 generates packets based on the selected stream. Concerning a video stream, typically, at most one video frame is conveyed in one packet, whereas concerning an audio stream, typically, a packet may comprise more than one audio frames. The channel encoder 117 performs channel encoding for the packets to produce the actual transmission data.

FIG. 5 shows another illustration of the server 111. The server 111 comprises a processing unit 151, a first memory 153, a network interface 155, and a second memory 152. The first memory 153, the network interface 155, and the second memory 152 are coupled to the processing unit 151.

The processing unit 151 controls, in accordance with computer software 154 stored in the first memory 153, the operation of the server 111, such as controlling the stream selector 118, the packetizer 116 and the channel coder 117 of FIG. 4. It controls processing of error resilience adaptation requests received from the client 101 and the sending of appropriate video and/or audio streams, stored in the second memory (disk) 152, to the client 101 via the network interface 350.

The software 154 comprises program code for implementing a protocol stack comprising necessary protocol layers such as, e.g., an RTP layer, an RTSP layer, an SDP layer, a TCP or UDP layer, an IP layer. Lower protocol layers may be implemented in a combination of hardware and software.

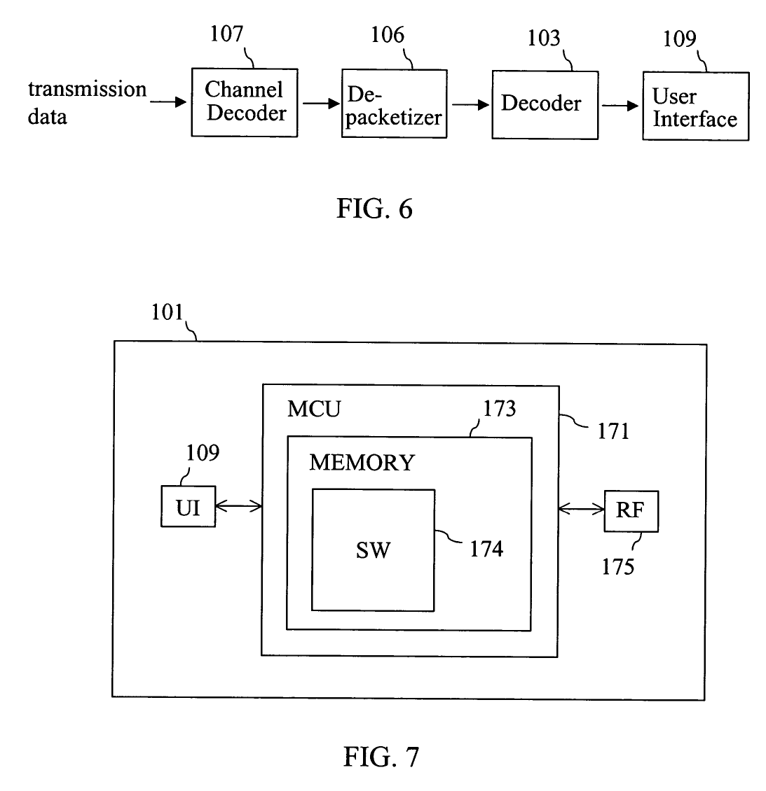

FIG. 6 illustrates a streaming client device 101 according to an embodiment of the invention. The client 101 comprises a channel decoder block 107, a de-packetizer block 106, a media decoder block 103 and a user interface 109. The channel decoder 107 performs channel decoding for the received transmission data packets. The de-packetizer 106 unpacks the received packets. The resulting stream is decoded in the decoder 103 before shown to the user via the user interface 109.

FIG. 7 shows another illustration of the client device 101. In this embodiment, the client 101 is a mobile station of a cellular radio telephone network. However, the client may, alternatively, be a fixed terminal.

The client 101 comprises a processing unit 171, a radio frequency part 175, and the user interface 109. The radio frequency part 175 and the user interface 109 are coupled to the processing unit 171. The user interface 109 typically comprises a display, a speaker and a keyboard (not shown) with the aid of which a user can use the client device 101.

The processing unit 171 comprises a processor (not shown), a memory 173 and computer software 174 stored in the memory 173. The processor controls, in accordance with the software, the operation of the client device 101, such as receiving streaming media from the server 111 and sending requests to the server 111 via the radio frequency part 175, presentation of the received streaming media on the user interface 109. The processing unit 151 also controls, in accordance with the software 154, the operation of the channel decoder 107, de-packetizer 106 and the media decoder 103 of FIG. 6.

The software 174 comprises program code for implementing a protocol stack comprising necessary protocol layers such as, e.g., an RTP layer, an RTSP layer, an SDP layer, a TCP or UDP layer, an IP layer. Lower protocol layers may be implemented in a combination of hardware and software.

The RTCP reports which the client 101 sends to the server via the radio frequency part 175 are also generated by the software based on information it gets from the protocol stack, e.g., via an application programming interface (API, not shown).

Embodiments of the present invention provide means for error resilience adaptation in a streaming service. With the error resilience adaptation as proposed in embodiments of the invention, the streaming service can adapt to the variation in network transmission error rate due to network condition changes, hence relatively better Quality of Service and user experience can be expected. The definition of error resilience levels enables efficient signaling of error resiliency capabilities for a streaming session control purpose.

Embodiments of the invention may be used to live-feed streaming, wherein a live video and/or live audio signal is encoded in real-time at the streaming server and is sent to the client device. They are also applicable to a streaming broadcast transmission. In these cases, error resilience adaptation may be performed on the basis of reports, such as RTCP reports, received from one or more clients.

Particular implementations and embodiments of the invention have been described. It is clear to a person skilled in the art that the invention is not restricted to details of the embodiments presented above, but that it can be implemented in other embodiments using equivalent means without deviating from the characteristics of the invention. The scope of the invention is only restricted by the attached patent claims.

1. A method for streaming media from a streaming server to a streaming client via a transmission channel, wherein the method comprises:
reducing effects caused by transmission channel error variation by applying error resilience adaptation to the streaming media.

2. The method of claim 1, wherein said error resilience adaptation comprises the use of a set of pre-defined error resilience levels to control streaming media transmission.

3. The method of claim 2, wherein said error resilience levels are defined in accordance with targeted highest data loss rate or packet loss rate.

4. The method of claim 1, wherein transmission channel error variation is noticed as a change in data loss rate or packet loss rate experienced at the client side.

5. The method of claim 1, wherein the method comprises:
sending, upon noticing a change in transmission channel condition, from the streaming client to the streaming server a request for error resilience adaptation;
receiving the request at the streaming server;
adapting, by the streaming server, the error resilience level of the streaming media in accordance with the request.

6. The method of claim 5, wherein said request is one of the following: a request for a specific error resilience level, an error resilience level increase request, an error resilience level decrease request.

7. The method of claim 1, wherein the streaming server receives from the client reports, such as RTCP reports (RTP Control Protocol (Real-Time Streaming Protocol)), indicative of transmission channel errors, and wherein the server decides on error resilience adaptation based on one or more of said reports.

8. The method of claim 1, wherein error resilience adaptation is performed during an ongoing streaming session established between the streaming client and the streaming server.

9. The method of claim 1, wherein a media stream at the streaming server is associated with an error resilience value indicating an error resilience level.

10. The method of claim 9, wherein said error resilience value is stored in a file format in which said media stream is stored.

11. The method of claim 1, wherein error resilience adaptation is performed by switching the streaming server from sending a first beforehand generated stream having a first error resilience level to sending a second beforehand generated stream having a second error resilience level, the second error resilience level differing from the first one.

12. The method of claim 1, wherein error resilience adaptation is performed by a transcoding method which comprises transcoding a media stream having a first level of error resilience to form a media stream having a level of error resilience differing from said first level.

13. The method of claim 1, wherein error resilience information is transferred between the streaming server and the streaming client.

14. The method of claim 13, wherein, in a streaming session setup, information on available different error resilience level alternatives is communicated to the client.

15. The method of claim 1, wherein the transmission channel is at least partially implemented via a mobile communications network.

16. The method of claim 15, wherein the streaming server has an IP connection (Internet Protocol) to an IP-based network which is configured to be coupled with the mobile communications network.

17. The method of claim 1, wherein said media to be streamed comprise at least one of the following: a video content, an audio content, a still image, graphics, text and speech.

18. A client device comprising:
receiving means for receiving streaming media sent from a streaming server to the client device via a transmission channel;
detection means for detecting transmission channel errors; and
sending means for sending an error resilience adaptation request to the streaming server.

19. The client device of claim 18, wherein the client device is a mobile station of a cellular network.

20. A streaming server comprising:
sending means for sending streaming media to a streaming client via a transmission channel; and
adaptation means for reducing effects caused by transmission channel error variation by applying error resilience adaptation to the streaming media.

21. A system comprising a streaming server, a transmission channel and a streaming client, wherein the system comprises:
transmission means for transmitting streaming media from the streaming server to the streaming client via the transmission channel; and
adaptation means for reducing effects caused by transmission channel error variation by applying error resilience adaptation to the streaming media.

22. A computer program product executable in a client device, the computer program product comprising:
program code for controlling reception of streaming media sent from a streaming server to the client device via a transmission channel;
program code for detecting transmission channel errors; and
program code for controlling sending of an error resilience adaptation request to the streaming server.

23. A computer program product executable in a streaming server, the computer program product comprising:
program code for controlling sending of streaming media to a streaming client via a transmission channel; and
program code for controlling error resilience adaptation applied to the streaming media.
